(19) United States
(12) Patent Application Publication
(10) Pub. No.: US 2006/0192372 A1
(43) Pub. Date: Aug. 31, 2006

(54) Coated sewing thread for airbag and method of sealing an airbag

(75) Inventor: Michel G. Khouri, Birmingham, MI (US)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC.

(21) Appl. No.: 11/066,808

(22) Filed: Feb. 28, 2005

(51) Int. Cl. B60R 21/16

(52) U.S. Cl. 280/743.1; 57/250; 428/378

(57) ABSTRACT

A thread for sewing occupant protection devices includes a spun thread and a thermoplastic elastomer coating. The thread can be used to form a sewn seam joining two fabric panels together to create an airbag. The seam can create needle holes in the two fabric panels. The seam can be heated after assembly of the airbag, such that the thermoplastic elastomer coating displaces off of the spun thread and fills in any needle holes.

### BACKGROUND

The present invention relates generally to the field of threads used in airbags and methods of sealing an airbag.

Conventionally, an airbag comprising a plurality of panels which are sewn together to form an envelope-like configuration has been employed as a driver's airbag, a front passenger's airbag, a rear passenger's airbag, or a side airbag installed in an automobile, or an airbag installed in an aircraft. The airbag is inflated with gas from an inflator.

In an airbag, such as a side airbag for protecting an occupant's head as a curtain-type airbag and a side airbag for protecting an occupant during a roll-over, an inner pressure in the airbag has to be kept high for a long period of time. Thus, it is required to prevent a gas leakage at a sewn portion. However, when the airbag is inflated, weaving yarns or threads are strongly pulled by a sewing yearn or thread to thereby widen interstices or make holes along the sewing yarn penetrating the panels of the airbag. The holes allow gas to leak through.

Conventional attempts to prevent such gas leakage include a tape, such as a silicone tape, that is attached to the airbag to cover a sewn portion of the fabric panels.

### SUMMARY

One embodiment of the invention relates to a thread for sewing occupant protection devices. The thread comprises a spun thread and a thermoplastic elastomer coating.

A second embodiment of the present invention relates to an airbag. The airbag comprises a first fabric layer, a second fabric layer and a sewn seam joining the first fabric layer and second fabric layer. The sewn seam comprises a coated thread that includes a thermoplastic elastomer.

A third embodiment of the invention relates to a method of sealing an airbag. The method comprises joining a first fabric panel and second fabric panel together with a sewn seam. The sewn seam comprises a coated thread.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a section view through a surface of an airbag in the area of two adjacent fabric panels connected by a seam according to an embodiment of the present invention.

FIG. 2 is a sectional view of a coated sewing thread taken along line A-A of FIG. 1.

FIG. 3 is a perspective view of an airbag with a sewn seam prior to heating.

FIG. 4 is a perspective view of the airbag of FIG. 3 after heating.

### DETAILED DESCRIPTION

Hereinafter, embodiments of the present invention will be described with reference to the attached drawings.

FIGS. 1, 3 and 4 show an exemplary airbag 20 for protecting an occupant in a vehicle. The airbag 20 comprises a first fabric panel 22 and a second fabric panel 24. The first fabric panel 22 and second fabric panel 24 are joined together by a sewn seam 10 along the peripheral edges of the fabric panels 22, 24. The airbag 20 is inflated by an inflator (not shown) through gas supplied through an inlet 32.

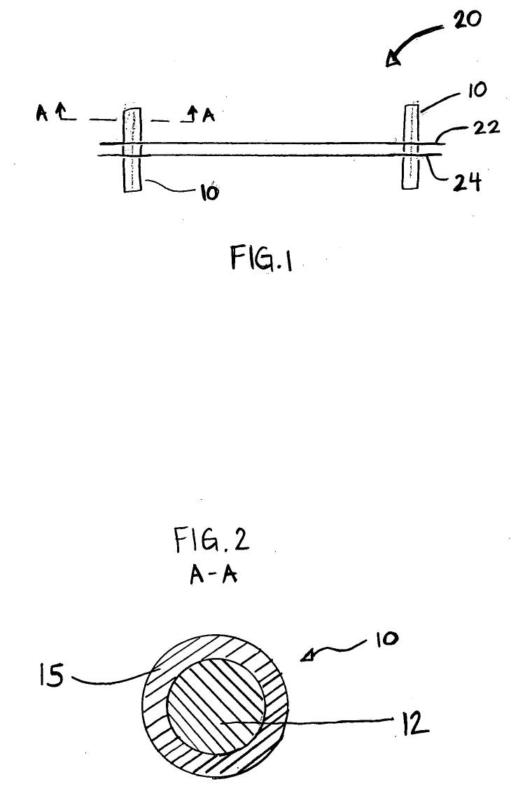

As shown in FIG. 1, the sewn seam 10 extends through both fabric panels 22, 24. The sewn seam 10 comprises a thread 12 with a coating 15, as can be seen in FIG. 2. The coating 15 is formed as an integral part of the thread 12. As the thread 12 is spun, the coating 15 is applied to the thread 12. The coating 15 surrounds the thread 12 and covers the entire surface of the thread 12.

The coating 15 comprises a thermoplastic elastomer. The thermoplastic elastomer can comprise, for example, styrenic block copolymers, thermoplastic vulcanizate, or thermoplastic polyurethane, or any other suitable thermoplastic elastomer.

The coating 15 is configured such that after exposure to heat, the coating 15 melts or flows off of the thread 12 and attaches to surrounding material, such as fabric panels 22, 24.

The sewn seam 10 can be heated by radiowave welding, ultrasonic welding, or any other suitable welding or heating technique. Alternatively, the sewn seam 10 can be heated by any other suitable method.

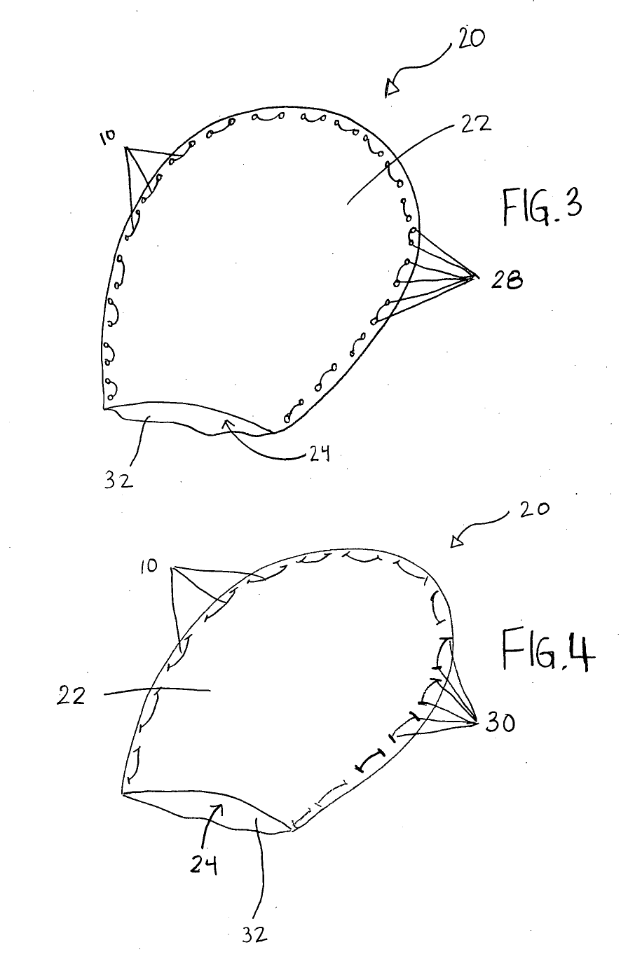

When the seam 10 is sewn onto the first 22 and second 24 fabric panels, needle or sewing holes 28 are created in the fabric panels 22, 24, as shown by example in FIG. 3. Weaving yarns or threads in the fabric panels 22, 24 are pulled apart by the sewing process (by the needle), creating these sewing holes 28. As the airbag 20 inflates, inflation gasses can escape through these sewing holes 28. Thus, according to this embodiment of the present invention, the sewn seam 10 can be created with the thread 12 having the surrounding coating 15. The seam 10 is then heated sufficiently, such that the coating 15 displaces off of the thread 12 and moves into the sewing holes 28, at least partially filling these holes 30 as can be seen in FIG. 4.

According to another embodiment of the present invention, the coating 15 applied to the thread 12 can comprise a compound of different materials. The compound can comprise a multitude of different thermoplastic elastomers, or can be a compound of thermoplastic elastomers and other coating materials. Further, the coating 15 need not be uniform throughout an airbag 20 or along a seam 10. Rather, the coating 15 can vary along the length of the thread 12. In another embodiment of the present invention, the coating 15 only partially surrounds the thread 12 and covers only a portion of the surface of the thread 12.

According to another embodiment of the present invention, the airbag 20 can be a driver side airbag, a passenger side airbag, a side curtain airbag, seat-mounted airbag or a knee airbag.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined with reference to the following claims.

What is claimed is:

1. A thread for sewing occupant protection devices, comprising:
a spun thread; and
a thermoplastic elastomer coating.

2. The thread of claim 1, wherein the thermoplastic elastomer coating is applied when the thread is spun.

3. The thread of claim 1, wherein the thermoplastic elastomer coating comprises styrenic block copolymers.

4. The thread of claim 1, wherein the thermoplastic elastomer coating comprises thermoplastic vulcanizate.

5. The thread of claim 1, wherein the thermoplastic elastomer coating comprises thermoplastic polyurethane.

6. An airbag, comprising:
a first fabric layer;
a second fabric layer; and
a sewn seam joining the first fabric layer and second fabric layer comprising a coated thread that includes a thermoplastic elastomer.

7. The airbag of claim 6, wherein the coated thread is configured to reduce a sewing hole in the first and second fabric layers.

8. The airbag of claim 7, wherein the coated thread is configured to fill the sewing hole.

9. The airbag of claim 7, wherein the coated thread is heated.

10. The airbag of claim 9, wherein the coated thread is heated by radiowave welding.

11. The airbag of claim 9, wherein the coated thread is heated by ultrasonic welding.

12. The airbag of claim 4, wherein the coated thread comprises styrenic block copolymers.

13. The airbag of claim 4, wherein the coated thread comprises thermoplastic vulcanizate.

14. The airbag of claim 4, wherein the coated thread comprises thermoplastic polyurethane.

15. A method of sealing an airbag, comprising:
joining a first fabric panel and second fabric panel together with a sewn seam,
wherein the sewn seam comprises a coated thread.

16. The method of claim 15, wherein the coated thread comprises a thermoplastic elastomer.

17. The method of claim 15, further comprising heating the sewn seam.

18. The method of claim 17, wherein the sewn seam is heated by radiowave welding.

19. The method of claim 17, wherein the sewn seam is heated by ultrasonic welding.

20. The method of claim 17, further comprising melting a portion of the coated thread and filling a sewing hole in the first and second fabric panels.
